(19) United States
(12) Patent Application Publication
(10) Pub. No.: US 2005/0001460 A1
(43) Pub. Date: Jan. 6, 2005

(54) Child passenger carrier for bicycles

(76) Inventors: Jessica Starodoj, Aspen, CO (US); Leslie Miller, Aspen, CO (US)

Correspondence Address: GLENN L. WEBB, P.O BOX 951, CONIFER, CO, 80433, US

(21) Appl. No.: 10/613,778

(22) Filed: Jul. 2, 2003

(51) Int. Cl. B62J 1/00

(52) U.S. Cl. 297/195.1

(57) ABSTRACT

A safe child passenger system that can be mounted on bicycles of differing sizes and designs. The system is able to be mounted to bicycles regardless of the size or placement of their top tube or even if there is no top tube present. The system of the present invention is attached to a bicycle by engagement between the handlebar stem of the bicycle and the seat post of the bicycle. The child passenger system attaches to a bicycle through a quick release engagement mechanism. This enables the system to be easily and quickly attached and removed.

### FIELD OF THE INVENTION

This invention is related to the field of child passenger carriers for bicycles.

### BACKGROUND OF THE INVENTION

It is often desirable to bring a child along on bicycle rides. This can be difficult to do safely and easily with prior child carriers that are mountable on bicycles. These types of carriers are typically trailers pulled behind the bicycle, rear mounted carriers mounted over the rear wheel of the bicycle, top tube mounted carriers and handlebar or basket mounted carriers. Each of these carriers have problems with the safety or mounting of the carrier on the bicycle.

Trailers have been used with varying success pulled behind bicycles. These trailers create an extended length combined with the bicycle that can create traffic hazards as well as cumbersome on bicycle paths and sidewalks. It is difficult for the bicyclist to monitor the safety of children in such trailers. Also, the bicyclist is unable to easily communicate with the children.

Rear mounted child carriers have been used with limited success in the past. These types of carriers are typically mounted over the rear wheel axle of the bicycle. The center of gravity of the bicycle is moved rearwardly as well which causes awkward handling of the bicycle. Further, the view of the child is blocked by the bicycle rider. Also, since the rider can not observe the child, the safety of the child may be at risk. Another safety disadvantage is that the legs of the child extends over the rear wheel which may pose a risk to the child.

Another problem with these types of carriers is the difficulty in the attachment and removal of the carrier. This process normally requires tools and special mounting hardware. Thus, the bicycle rider will normally be forced to leave the carrier mounted to the bicycle even when the child is not accompanying the ride.

Another type of child carriers for bicycles are top tube mounted carriers. These carriers are typically mounted to the top tube of the bicycle. An additional mounting mechanism may also attach to the seat post or the handlebar stem of the bicycle as well. The attachment to the top tube creates difficulty in the attachment of the carrier to the bicycle. The design, placement, size, and other features of the top tube differs between bicycles. Many bicycles do not even have a top tube, such as women bicycles, and high end full suspension mountain bicycles. Also, the clamping mechanisms for these top tube mounted carriers may interfere with the brake and shifting cables.

Thus a need exists for a child passenger system that can be quickly mounted onto differing sizes and designs of bicycles for securely and safely holding a child during a bicycle ride.

### SUMMARY OF THE INVENTION

The present invention provides the solution to these and other problems by providing a safe child passenger system that can be mounted on bicycles of differing sizes and designs. The child passenger system of the present invention is designed to provide safety, comfort and enjoyment for children sharing a bicycle ride. It overcomes many of the objections to the previous child passenger systems.

In a preferred embodiment of the present invention, the child passenger system is able to be securely attached to bicycles of varying sizes and designs. The system of this embodiment is able to be mounted to bicycles regardless of the size or placement of their top tube or even if there is no top tube present. The system of the present invention is attached to a bicycle by engagement between the handlebar stem of the bicycle and the seat post of the bicycle, thus the top tube is of no concern.

The child passenger system of a preferred embodiment of the present invention attaches to a bicycle through a quick release engagement mechanism. This enables the system to be easily and quickly attached and removed. Thus, the system will be more often utilized as special tools and hardware are not required every time the system is to be used. In a particular embodiment, the system uses an open-ended yoke that engages quickly around the handlebar stem of bicycle and rear seat post clamp that attaches by a quick release bolt to the frame member of the system. This allows the system to be attached by simply engaging the front yoke around the handlebar stem and the insertion of a quick release bolt.

The seat post clamp, in a preferred embodiment, uses a vertical swivel in attaching to the frame member of the system. This allows the frame member to be maintained in substantially horizontal orientation regardless of the angle or placement of the seat post of the bicycle. This increases the usability of the system with different bicycles. Special hardware is not required for each bicycle design or size.

The system of a preferred embodiment includes a five point harness system to securely fasten a child in the seat of the system. This five point harness system engages the child over the back, shoulders and lap of the child and is easily adjusted to fit most children. Thus, the child is safe and secure in the child passenger system of this embodiment.

In a preferred embodiment of the present invention, an adjustable foot rest system is provided so that harm to the legs of a child in the system is minimized from engagement in the wheels of the bicycle or during an accident. The foot rests can be adjusted to fit the size of a particular child.

A handlebar is provided in a preferred embodiment of the present invention for the child to grasp during a ride. The handlebar may include a protective foam material to minimize vibration and shock during the ride.

Another feature of a preferred embodiment is a toy attached to the handlebar system for the enjoyment of the child during a ride. The toy may be permanent or replaceable.

These and other features of the present invention are evident from the ensuing detailed descriptions of preferred embodiments and from the drawings.

### BRIEF DESCRIPTION OF THE DRAWINGS

FIG. 1 is a perspective view of a preferred embodiment of the child passenger system of the present invention.

FIG. 2 is a side view of the embodiment of FIG. 1.

FIG. 3 is a detailed view of the rear seat post clamp of the embodiment of FIG. 1.

FIG. 4 is a detailed view of the front yoke engagement mechanism of the embodiment of FIG. 1.

### DETAILED DESCRIPTION OF PREFERRED EMBODIMENTS

The present invention, in a preferred embodiment, provides a unique child carrier system for bicycles. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

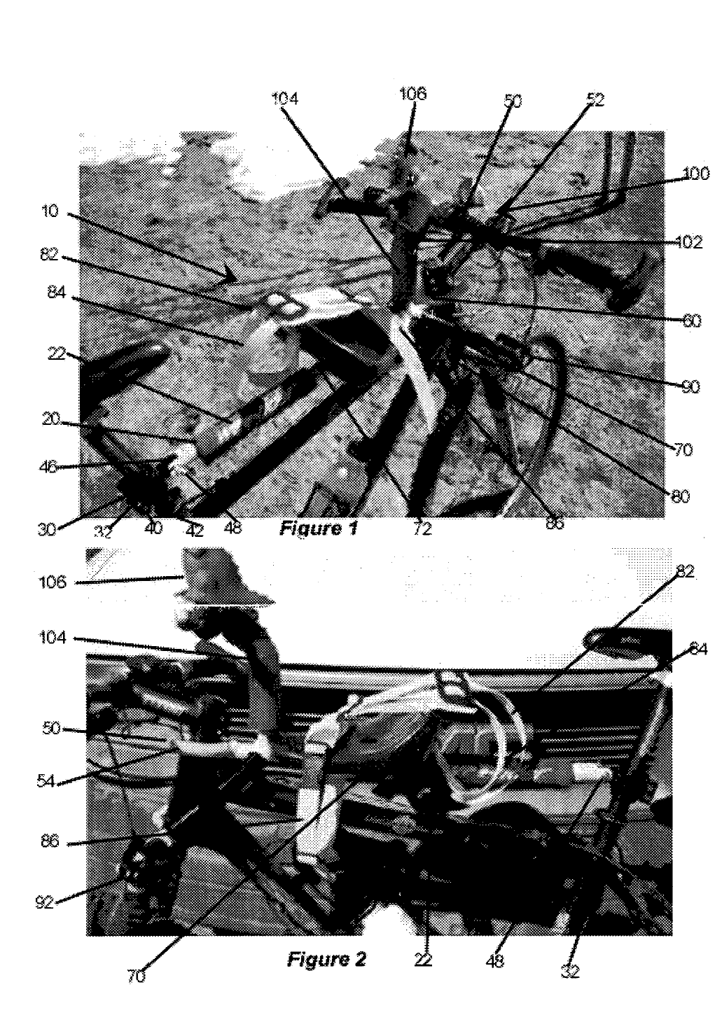

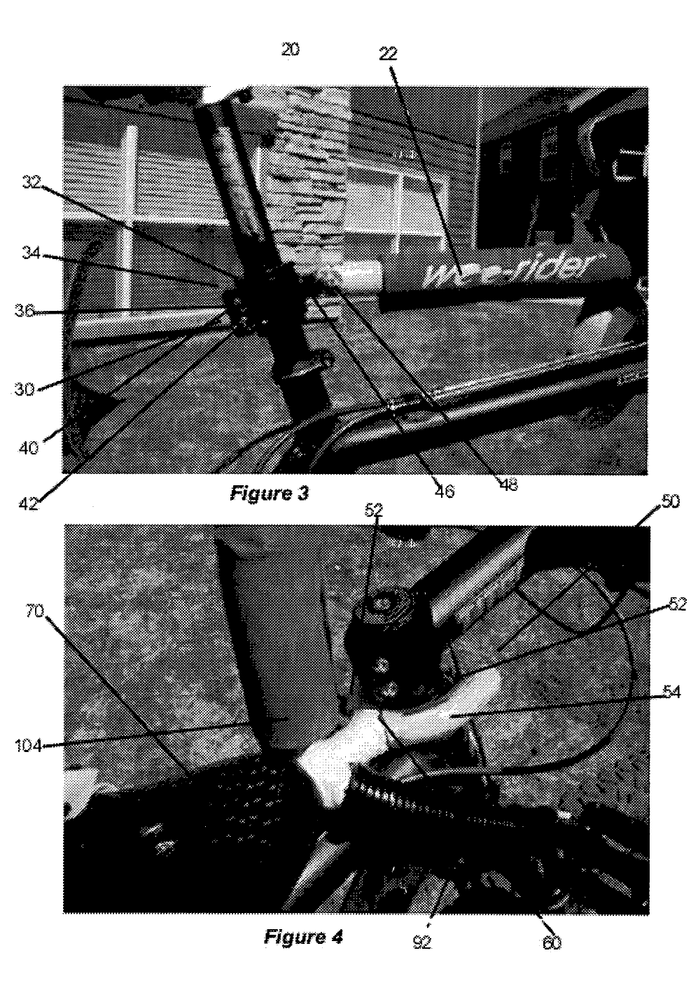

A preferred embodiment of the child passenger carrier system of the present invention is illustrated in FIGS. 1-4. The child passenger carrier system 10 of this preferred embodiment includes a frame member 20. In the preferred embodiment, the frame member 20 is formed from a high strength thin walled tubing, but it is to be expressly understood that other materials may be used as well, including but not limited to aluminum, titanium, plastic and other suitable materials. The frame member 20 is an elongated member that extends substantially horizontally between the seat post and the handlebar stem of a bicycle as discussed in greater detail below.

In one preferred embodiment, the frame member 20 includes the ability to be telescoped to change the length of the frame member depending on the size and design of the bicycle onto which it is to be attached. The capability includes using two differing size diameters of frame members to enable one to fit within the inner diameter of the other. Clamps, bolts or other locking mechanisms may be used to lock the frame member in the desired length. Other mechanisms may also be used to change the length of the frame member as well.

The exposed portions of the frame member 20 are covered by protective foam members 22. These provide protection to the child from banging against those areas of the frame member as well as from scratching the bicycle.

Seat post clamp 30 includes a tubular clamp 32, that is two separable pieces 34, 36 bolted together to form an inner tubular diameter for clamping around a bicycle seat post 38. The two clamp pieces 34, 36 are secured together by bolts 40, 42. A third bolt 44 or interlocking tongue can be used on the opposing side. The clamp 32 includes an extension 46 having an aperture (not shown) formed through it.

The frame member 20 is attached to the extension 46 by bolt 48 extending through the aperture of the extension 46. The bolt 48 may also be a quick release mechanism as well to allow quick removal and attachment of the frame member 20 to the bicycle. The attachment of the frame member 20 to the extension 46 of the seat post clamp 30 also provides a vertically swivel point as well. This important feature allows the child passenger system 10 to accommodate almost all bicycles regardless of the angle or height of the seat post of the bicycle. The frame member 20 is able to swivel relative to the seat post clamp 30 to maintain a substantially horizontal position relative to the bicycle. In the preferred embodiment, the clamp 30 remains permanently mounted onto the bicycle while the frame member may be easily removed by the bolt 48.

The child passenger system 10 also includes a front yoke 50. In the preferred embodiment, the front yoke 50 includes a substantially “U” shaped end 52 having arms 54, 56. The front yoke 50 of the child passenger system 10 is formed of a high strength sold steel material. It is to be expressly understood that other materials may be used as well, including but not limited to aluminum, titanium, plastic and other suitable materials. In the preferred embodiment, the front yoke 50 includes a protective coating of plastic or other non abrasive material. The opening 58 formed between arms 54, 56 is able to embrace the handlebar stem of most if not all bicycles. The mid portion 60 between the arms 54, 56 is able to abut against the handlebar stem, as shown in FIG. 4.

The child passenger system 10 also includes a seat 70 attached to the frame member 20, as shown in FIGS. 1 and 2. The seat 70, in the preferred embodiment, is molded out a durable plastic to fit most small children. It is to be expressly understood that other materials, sizes and designs may be used as well. The seat 70 also includes a five point harness system 80 to hold a child safely in the seat 70. The five point harness system 80 includes a first strap 82 that comes from beneath both sides of the bottom 72 of the seat 70. This strap 82 clasps over the lap of the child. The second strap 84 comes from over back of the child. Strap 84 crosses over the shoulders of the child the lap strap portion 86 of the strap 82. Thus, a child is securely restrained onto the seat 70 of the preferred embodiment of the child passenger system.

In a preferred embodiment of the present invention, the child passenger system includes foot rests 90, 92. These foot rests extend outwardly from the frame member 20 and are designed to be vertically adjustable. This enables the child passenger system to be used with varying sizes of children. The foot rests 90, 92 will minimize the risk of a child engaging their feet and legs in the bicycle wheels as provide a protective barrier in the event the bicycle falls over.

Another feature of a preferred embodiment of the present invention includes a handlebar system 100 on the child passenger system. The handlebar 102 extends upward from the frame member 20 near the front yoke 60. In the preferred embodiment illustrated in FIGS. 1-4, the handlebar 102 includes a protective foam portion 104 to minimize harm to the child in the seat 70 as well as to provide comfort to the child in the vibrations and shock during the bicycle ride. The illustrative embodiment also includes a toy shaped portion 106 to increase the enjoyment of the child. Another important benefit of the child handlebar system is that it will minimize the tendency of a child grabbing onto the bicycle handlebar or the rider. The child will be occupied with their own handlebar and/or toy, and will not disrupt the handling of the actual bicycle.

In use, the child passenger system 10 can be quickly and easily installed. The seat post clamp 30 is clamped around the seat post of the bicycle by securing the tubular clamp 32 around the seat post and tightening bolts 40, 42. The frame member 20 is attached to the seat post clamp bolt 48. The front yoke 50 is slipped around the handlebar stem by the opening 58. The length of the frame member 20 can be adjusted if necessary to ensure that there is a firm engagement of the mid portion 60 of the front yoke 50 against the handlebar stem. If necessary, the seat post clamp 30 can be moved up or down the seat post until the frame member 20 is substantially horizontal. The bolts 40, 42 and 48 can then be tightened. The frame member 20 is then securely fastened to the bicycle regardless of the size or design of the bicycle, particularly in respect to the top tube, seat post and handlebar stem of the bicycle.

A child can then be placed onto the seat 70 and secured therein by the harness system. The harness straps are placed over the back and shoulders of the child as well as across the lap of the child. This prevents accidental dislodgement of the child from the seat even in the event of an accident. The foot rests can be adjusted so the child can comfortably rest their feet there and out of harms way. The child can then grasp the handlebars 102 if desired to be comfortable and enjoy the ride. The arms of the rider will also protect the child during the normal course of a ride.

The present invention as described above and as set forth in the claims provides a safe bicycle carrier system for small children to accompany a skilled rider. The system is easily secured onto a bicycle regardless of the design and size of the bicycle. It can be easily and quickly attached and removed so that it will be more often utilized. The above descriptive embodiments were provided only for explanatory purposes and were not meant to limit the scope of the present invention. Each of the features and components discussed above and set forth in the claims may be used either alone or in combination with one or more of the remaining features and components.

1. A child carrier passenger system for bicycles, said system comprising:
a frame member;
a child seat attached to said frame member;
a mechanism for engaging onto a bicycle handlebar stem; said mechanism is attached to a first end of said frame member; and
a rear clamp for attachment to a seat post of a bicycle; said rear clamp attached to a second end of said frame member.

2. The child carrier passenger system of claim 1 wherein said mechanism for engaging onto a bicycle handlebar stem includes:
a substantially “U” shaped open ended yoke for engagement around the handlebar stem of most bicycles.

3. The child carrier passenger system of claim 1 wherein said mechanism for engaging onto a bicycle handlebar stem includes:
a substantially “U” shaped open ended yoke for engagement around the handlebar stem of most bicycles; and
a protective coating on said front yoke to minimize scratching of the handle bar stem.

4. The child carrier passenger system of claim 1 wherein said rear clamp includes:
a vertical swivel to enable said frame member to be attached to most bicycle seat posts regardless of the angle of the seat post.

5. The child carrier passenger system of claim 1 wherein said rear clamp includes:
a quick release mechanism to enable said system to be quickly attached to a bicycle and removed from the bicycle.

6. The child carrier passenger system of claim 1 wherein said system includes:
a harness system attached to said seat to secure a child in said seat.

7. The child carrier passenger system of claim 1 wherein said system includes:
a five point harness system attached to said seat to secure a child in said seat.

8. The child carrier passenger system of claim 1 wherein said system includes:
a foot rest for a child secured in said seat.

9. The child carrier passenger system of claim 1 wherein said system includes:
an adjustable foot rest for a child secured in said seat.

10. The child carrier passenger system of claim 1 wherein said system includes:
a handlebar system for the child.

11. The child carrier passenger system of claim 1 wherein said system includes:
a handlebar system for the child; and
a toy mounted on said handlebar system.

12. The child carrier passenger system of claim 1 wherein said system includes:
an adjustable length frame member.

13. A method for using a child passenger system having a front engagement mechanism, a central frame member, a child's bicycle seat attached to said central frame member and a rear clamp, said method comprising the steps of:
engaging said front engagement mechanism onto a handlebar stem of a bicycle;
attaching said rear clamp to the seat post of the bicycle; and
securing a child in said child's bicycle seat.

14. The method of claim 13 wherein said step of engaging said front engagement mechanism onto a handlebar stem of a bicycle also includes the steps of:
said front engagement mechanism having an open end; and
engaging said open end of said front engagement mechanism around the handlebar stem of a bicycle.

15. The method of claim 13 wherein said step of attaching said rear clamp to the seat post of the bicycle includes the step of:
said rear clamp including a vertical swivel; and
adjusting said vertical swivel on said rear clamp until said central frame member is substantially horizontal.

16. The method of claim 13 wherein said step of securing a child in said child's bicycle seat includes the steps of:
said child's bicycle seat having a harness system; and
securing said harness system around the child to securely retain a child in said bicycle seat.

17. The method of claim 13 wherein said step of securing a child in said child's bicycle seat includes the steps of:
said child passenger system having adjustable foot rests; and
adjusting said adjustable foot rests so a child can comfortably rest their feet.

18. The method of claim 13 wherein said step of securing a child in said child's bicycle seat includes the steps of:
providing a handlebar on said child passenger system for a child to grasp during a bicycle ride.

19. The method of claim 13 wherein said method further includes:
providing a quick release on said rear clamp to enable said central frame member to be easily removed.

20. The method of claim 13 wherein said method further includes:
providing an adjustable length mechanism on said central frame member to accommodate differing sizes and designs of bicycles.
